(19) United States
(12) Patent Application Publication
(10) Pub. No.: US 2001/0010254 A1
(43) Pub. Date: Aug. 2, 2001

(54) STAIN RESISTANT COATING MATERIAL

(76) Inventors: ARTHUR LANDAU, BREWSTER, NY (US); SEAN DES ROCHES, RANDOLPH, NJ (US)

Correspondence Address: SCHWEITZER CORNMAN GROSS & BONDELL LLP, 230 PARK AVENUE, NEW YORK, NY, 10169

(21) Appl. No.: 09/390,399

(22) Filed: Sep. 3, 1999

Related U.S. Application Data
(60) Provisional application No. 60/099,278, filed on Sep. 4, 1998.

(51) Int. Cl. C09J 5/00; B05D 3/02; B05D 3/06

(52) U.S. Cl. 156/324; 427/510; 427/558; 427/258; 427/177; 427/316

(57) ABSTRACT

Application of radiation curable coatings to a flexible vinyl web, which is usually printed with a decorative pattern. This printed vinyl may be laminated to a backing for support and is often embossed. The actinically irradiated coated vinyl surface has improved stain resistance and is resistant to chemical attack by common as well as aggressive household cleaning solvents such as pine oil cleaners and nail polish remover. The coating is essentially free of hazardous volatile organic compounds and does not pose a toxicological threat to humans nor does it contaminate the atmosphere. These surface coated, actinically crosslinked vinyl laminates can be used in the manufacture of wallcoverings, automotive interiors, upholstery, tablecloths and other such applications especially where heat sensitive plastics are employed.

This application is a continuation of U.S. provisional application Ser. No. 60/099,278 filed Sep. 4, 1998.

### FIELD OF INVENTION

This invention relates to a vinyl laminate, primarily used as wallcovering. It is further directed to a clear layer with stain resistant properties which has been cured by exposure to actinic light. The vinyl is usually printed and/or embossed. The invention is directed to the method of producing the stain resistant vinyl laminate and the coating composition used thereon.

### SUMMARY OF PRIOR ART

In the preparation of vinyl wallcoverings with stain resistant coatings applied to the surface a number of patents are cited herein. In U.S. Pat. No. 4,603,074 Joseph L Pate and Dalton I. Windham Jr. have disclosed a polyester-amino resin composition in a solvent which requires heating at 200 degrees Fahrenheit or higher to effect crosslinking. The use of solvent in the coating renders this technology environmentally non-compliant to established U.S. EPA guidelines as of this date. The temperature necessary in order to effect crosslinking of this coating requires the vinyl to be laminated for support before coating. The time required to cause crosslinking to occur requires a long oven when a web is moving at reasonable production speeds. If the coating defined in U.S. Pat. No. 4,603,074 is alternately applied to the surface of the laminated and embossed vinyl the high temperature required for crosslinking this coating will also cause a loss of embossing definition. It is obvious to one skilled in the art that the coating must be applied after lamination but before embossing in order to keep the vinyl form distorting due to web tension at the elevated temperature required for crosslinking.

Similar shortcomings can be found in U.S. Pat. Nos. 5,721,309 and 5,594,061 granted to Satish C. Sharma, John C. Kovalchin, and Raymond Weinert. These patents disclose another heat reactive crosslinkable stain resistant coating with similar shortcomings. Theses disclosures of water based acrylic based coatings claim easier stain removal and environmentally accepted volatiles i.e. water, but do not reduce the time and temperature for crosslinking and simultaneous development of stain resistance. A vinyl web unsupported will not be dimensionally stable at 200 degrees Fahrenheit and extraordinarily long ovens are required at lower temperatures in order to develop stain resistance. These acrylic-melamine water based systems are well known and not new to those skilled in the art and the kinetics as of this date are also clearly known.

Another patent U.S. Pat. No. 4,100,318 is directed to a stain resistant coating for cushioned flooring and method for producing such flooring. The radiation curable coating is applied after embossing. The control of film thickness in the hills and valleys is a variable even at the very high viscosities disclosed. Furthermore this invention is limited to gloss coatings and does not deal with the loss of stain resistance as gloss is reduced.

### SUMMARY OF THE INVENTION

The present invention is directed to the product and process of manufacturing wallcoverings which are surface coated and actinically crosslinked, resulting in a solvent resistant, stain resistant, and simultaneously flexible wallcovering surface. The use of light rather than heat to cure or crosslink the coatings of this invention enables vinyl film to be processed in web form in relatively thin films, preferably, but not necessarily without being prelaminated before coating.

In accordance with the preferred aspect of the present invention low gloss as well as high gloss coatings have been shown to be stain resistant when properly formulated. Since low gloss or matte coatings are usually less stain resistant but most commonly used in wallcoverings, the compositions in the present invention disclose a method and compositions for attaining stain resistance and gloss control simultaneously.

A still further aspect of the invention is the adjustment of the surface tension and viscosity for applying a smooth, continuous thin coating to a non-porous substrate.

Yet another aspect of this invention is the discovery that environmentally acceptable viscosity reduction can be accomplished without the use of reactive diluents which are often toxic to humans on exposure. The viscosity reducers which are meant to be illustrative but not limiting are water, acetone, flourinated hydrocarbons and ethoxylated and non ethoxylated acrylic reactive diluents.

The vinyl chloride polymer film, supported or unsupported, printed or unprinted is preferably embossed to texture the surface thus providing a more aesthetically pleasing appearance. The coating composition of this invention can be post embossed without fracturing the continuous nature of this stain resistant coating which would then render it porous and susceptible to penetration and staining.

### DESCRIPTION OF METHOD

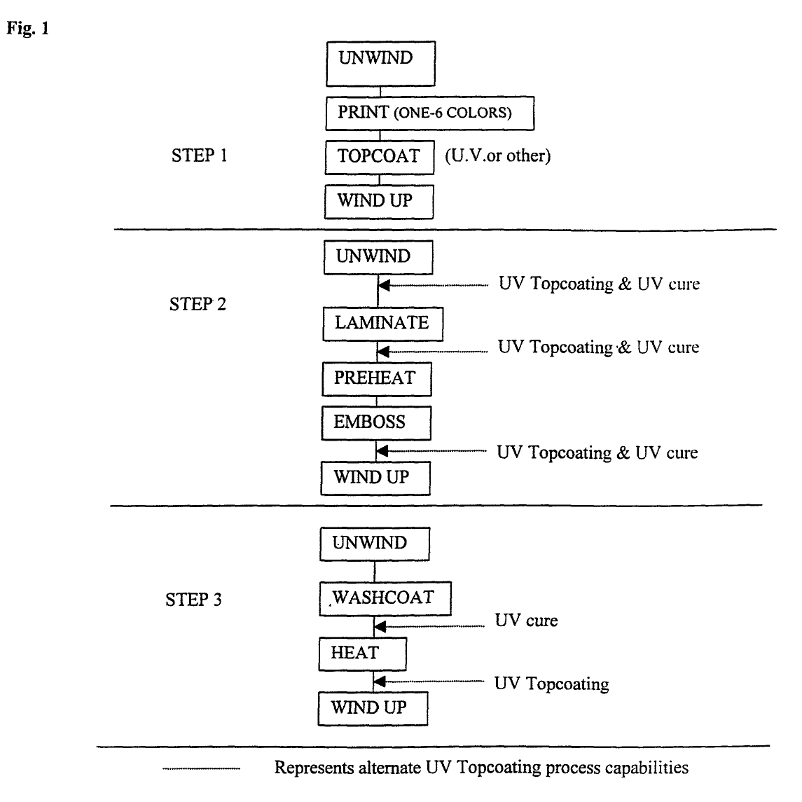

Embossed vinyl wallcovering is usually produced as in FIG. 1 of the drawings. It can be seen from the flow chart that the PVC film is usually printed on a one to six color gravure press as a first step. With the UV coating of this invention topcoating and ultra violet curing can be included in STEP 1 after printing but before rewinding. The unsupported vinyl is intentionally kept below 180 degrees Fahrenheit since dimensional stability of unsupported vinyl would be compromised due to the thermoplastic nature of plasticized PVC film.

Alternately, if preferred, the UV curable system of the present invention may be applied during the lamination and embossing step. See STEP 2. The advantage of topcoating during this step is due to the slower speed usually used during the lamination step compared to step 1, printing. As a result less space is required for a light source in order to effect cure, thereby reducing cost of installation and operating cost for UV curing. Since in-line application and cure is preferred the application in step 2 can be after unwind but before lamination, after lamination but before embossing or after embossing but before wind up in step 2.

If washcoating is used than a topcoating could be applied after drying the wash coating but before wind up. Alternately, a tinted washcoating could impart stain resistance if UV cured. The thin film thickness on the high points of the embossing and corresponding heavy film thickness in the valleys makes this step less desirable but certainly feasible.

### DESCRIPTION OF PREFERRED EMBODIMENT

The wet film thickness of the actinically cured coatings are effective from about 0.1 mils to 2 mils, more preferably from 0.2 to 1.2 mils, and most preferably from 0.3 to 1.0 mils. The dry film thickness will vary according to the volume solids of the coating applied (see chart 1) and usually but not always falls between 0.1 mils and 1.0 mils. Thinner coatings are less stain resistant and thicker films show some loss in flexibility, adhesion, and gloss pick-up which is undesirable in the wallcovering industry.

The methods of applying such topcoatings may include but are not limited to direct gravure, offset gravure, air knife, curtain coating etc. The surface tension of the water containing coatings is adjusted to between 28-38 dynes per centimeter squared. The vinyl surfaces have surface tensions of 30-40 dynes per square centimeter.

The degree of crosslinking which occurs under UV light is measured by recording the number of double rubs which causes coating removal, when such rubs are performed using a conventional paper towel saturated with methyl ethyl ketone. One stroke back and forth across the coated surface is recorded as one stroke. The resistance of the cured film is also measured by its resistance to isopropyl alcohol, pine oil, nail polish remover, and similar products which may be advantageously used to remove various staining materials commonly found in the home, industrial or hospital environment. Examples of specific cleaning products are Formula 409, rubbing alcohol, Pine Sol, and nail polish remover.

It is additionally disclosed herein that the vinyl film formulation has a dramatic and surprisingly significant effect on the retention of stains. The choice of vinyl resin, plasticizer type and concentration, fillers, stabilizers, and other additives commonly employed renders the vinyl film more or less susceptible to stain retention after the application of cleaning compound.

The vinyl film gravure printed in step 1 of FIG. 1 is usually wound up and in a second step, it is laminated to a woven fabric i.e. scrim. A plastisol adhesive or water based adhesive is applied to the unprinted side of vinyl film, brought together with the scrim, then passed over a heated drum between 225-350 degrees Fahrenheit under pressure. The UV curable topcoating may be applied and cured before the lamination or after the lamination but preferably before embossing. The control of gloss is mainly achieved by the addition of matting agents, which are sometimes brought to the surface by a low intensity pre-cure or pre-heat drier. The migration of the matting agent to the surface is an unexpected discovery and an integral part of this disclosure since it enables the formulator to use relatively low quantities of matting agent which renders the resultant film less porous and therefore less susceptible to the penetrating effect of staining chemicals.

The combination of properties for a polymerizable coating which are intended to be included under the scope of this invention are solvent resistance, flexibility, adhesion, stain resistance and usually low gloss and sheen.

Ultra violet light curable coatings included for illustrative purposes but not meant to be inclusive were produced having the following formulations in parts by weight.

### EXAMPLES

All samples were cured at a minimum of 40 feet per minute, 400 watts per square inch using Fusion s D bulb.

### Example 1

The ingredients listed are commercially available and the suppliers indicated. After mixing, the material was applied using a #3 wire wound rod which deposited a dry film thickness of approximately 7 microns after UV exposure. This gloss coating was exposed to the stress listed below for 24 hours and cleaned with “409”, a common household cleaner.

| | |
|---|---|
| Laromer 8894 (BASF) | 89.95 |
| MDEA* | 3.00 |
| 523 X F (Micro Powders) | .50 |
| Uvirex OB (Ciba) | .05 |
| BP (benzophenone) | 6.00 |
| DC-57 (Dow Corning) | .50 |
| | 100.00 |
| MEK rubs | 60 |
| Flexibility | Pass |

Stain resistance (see table below)(Cleaned with “Formula 409”)

| | |
|---|---|
| Avery Dennison Permanent Red Maker | Pass |
| Avery Dennison Permanent Blue Marker | Pass |
| Blue BIC ball point pen | Pass |
| Black BIC ball point pen | Pass |
| Red Sharpie | Pass |
| Blue Sharpie | Pass |
| Black Sharpie | Pass |
| King Size ™ Permanent Marker (Sanford) | Pass |

*n-methyl diethanolamine
Pass = no stain remaining

### Example 2

The same ingredients listed in example 1 were used with Laromer 8846 replacing Laromer 8894 on an equal weight basis. The resultant glossy UV cured surface had essentially the same resistance and flexibility on vinyl film as example 1. The stain test of example 2 left only very slight residual stain for Avery Denison Blue, Red, Sharpie, Blue Sharpie and Black Permanent marker.

### Example 3

A base A, consistency of reactive monomers, amine synergists, fluorocarbon wax, optical brightener, sphotoinitiate and silicone, was compounded and used to evaluate a series of oligomers.

Base A

| | |
|---|---|
| SR454 (Sartomer-reactive monomer) | 23.12 |
| TMPTA-N (reactive monomer) | 3.47 |
| TPGDA (reactive monomer) | 61.79 |
| MDEA (amine synergist) | 3.47 |
| 523 × F (Micro Powders-Wax) | 0.58 |
| Uvitex OB (Ciba optical brightener) | 0.06 |
| BP (beazophenone) | 6.94 |
| DC-57 (Dow Corning) | 0.57 |
| | 100.00 |

83.5 parts of “base A” was blended with 13.5 parts of the oligomers listed below. #3 wire wound rod drawdowns were made on a commercially available vinyl film, UV cured and evaluated for adhesion flexibility, solvent, and stain resistance.

| | Adhesion | Flexibility | MEK(Rubs) | Stain Test |
|---|---|---|---|---|
| Laromer LR 8828 | P | G | 70 | sl stain |
| (BASF) | | | | |
| Laromer PE 55F | P | G | 85 | sl stain |
| (BASF) | | | | |
| CN 120 (Sartomer) | P | G | 100 | sl stain |
| Laromer 8765 (BASF) | P | G | 75 | sl stain |
| Ebecryl 3701 | P | G | 100 | sl stain |
| Laromer PO43F | P | G | 100 | sl stain |
| Laromer LR8894 | P | E | 85 | sl stain |
| Laromer 8864 | P | G | 85 | sl stain |
| Laromer 8946 | P | G | 100 | sl stain |
| Ebecryl EB3702 | P | G | 85 | sl stain |
| Sartomer CN104 | P | G | 95 | sl stain |
| Ebecryl 830 (UCB) | P | G | 85 | sl stain |

P = Pass (Scotch tape adhesion)
G = Good flexibility
E = Excellent flexibility
MEK = methyl ethyl ketone double rubs to failure
Stain test was performed using the markers from example 1, for 24 hours, then removing with “409” (household cleaner only) 50 rubs
Sl = slight stain remaining
V. Sl = very slight stain remaining

### Example 4

A matte UV curing topcoat was prepared by blending the following ingredients. This coating was applied. UV cured and tested the same as in example 1 above. The results of adhesion, flexibility, gloss, solvent resistance and stain resistance are recorded below.

| Laromer LR 8894 | | 24.05 |
|---|---|---|
| TMPTA | | 10.68 |
| HDODA | | 23.39 |
| DC-57 | | 0.38 |
| 523XF | | 0.38 |
| Uvitex OB | | 0.04 |
| TZT (Trimethyl benzophenone blend) | | 3.98 |
| Huber 35 (J.M. Huber) | | 23.64 |
| Zeolex 70HP (J.M. Huber) | | 7.96 |
| Syloid 74 × 6000 (W.R. Grace) | | 2.96 |
| PNB | | 2.54 |
| Gloss | 60 deg. | 10 |
| | 85 deg. | 20 |

| | |
|---|---|
| Adhesion (Vinyl-scotch tape) | Pass |
| Flexibility | Pass |

Stain resistance (example 4)-10 min test Permanent Markers

| | | 409 (household | Rubbing |
|---|---|---|---|
| | | cleaner) | Alcohol |
| Marks-A-lot ® (Avery Dennison) | Red | no stain | no stain |
| Marks-A-lot ® (Avery Dennison) | Blue | no stain | no stain |
| BIC Ball point | Blue | v sl stain | no stain |
| BIC Ball point | Black | no stain | no stain |
| Sharpie (Sanford) | Red | v sl stain | vvsl stain |
| Sharpie (Sanford) | Black | some stain | v sl stain |
| Sanford ® King Size ™ | Black | sl. stain | v al stain |
| Permanent marker | | | |

### Example 5

A water based UV curable coating for vinyl film was prepared using the following ingredients and blended as in previous examples. A dulling compound was first prepared then mixed with commercially available water miscable obgomers.

Dulling Compound SD 118-1B

| | |
|---|---|
| Water | 68.266 |
| Proxcel GXL | .146 |
| Patco 597 | .530 |
| Teigitol WP-9 (Union Carbide) | 2.060 |
| Syloid 74 × 6000 | 14.922 |
| | 85.924 |
| Matte Topcoat (Water Based UV SD157-1B) | |
| Laromer 8949 | 58.02 |
| SD-118-1B | 34.06 |
| KIP100F | 1.99 |
| OT-75 (Cytec) | 0.54 |
| Acrysol RM 2020 | 4.31 |
| Acrysol RM 8W | 1.08 |
| | 100.00 |

### Example 6

A water based topcoat was prepared as in example 5.

Matte Topcoat (Water based UV-SD 159-1D)

| | |
|---|---|
| Laromer 8895 | 19.37 |
| Laromer 8949 | 37.67 |
| SD-118-1B | 31.59 |
| Esacure KIP100F (Sartomer)* | 1.85 |
| OT-75 | 0.5 |
| Acrysol RM-2020 | 4.0 |
| Acrysol RM-8W | 1.0 |
| Water | 7.54 |
| | 103.52 |

*alpha hydroxyketone

### Example 7

A water based topcoat was prepared as in example 5 and 6.

Matte Topcoat (Water based UV-SD 168-1A

| | | |
|---|---|---|
| Laromer PE 55W | 64.58 | (Polyester-50% in water) |
| SD-118-1B | 31.59 | |
| SR502 (Sartomer)* | 8.00 | |
| KIP100F | 2.08 | |
| Acrysol RM-2020 | 4.00 | |
| Acrysol RM-8W | 1.00 | |
| | 111.25 | |

| | Example 5 | Example 6 | Example 7 |
|---|---|---|---|
| MEK rubs | 40-50 | 40-50 | 75 |
| Flexibility | Pass | Pass | Pass |
| Adhesion | Pass | Pass | Pass |

*ethoxylated trimethylol propane triacrylate

Example 5—Stain resistance (24 hour test)

| | | Rubbing | Nail Polish |
|---|---|---|---|
| | 409 | Alcohol | Remover |
| Marks-A-lot (Avery Dennison Blue) | sev st | sl. sl. | vv sl. |
| Marks-A-lot (Avery Dennison Red) | sl. st | no stain | no st. |
| BIC Ballpoint Blue | sev. st. | mod. st | no st. |
| BIC Ballpoint Black | sev. st. | mod. st. | no st. |
| Sharpie (Sanford) Red | sev. | mod. st. | vv sl |
| Sharpie (Sanford) Black | sev. | mod. st. | vv sl |
| French's Mustard | no st. | no st. | no st. |

Example 6 stain results similar to example 5

Example 7 stain results.

| | | Pine Oil | Nail Polish |
|---|---|---|---|
| | 409 | Cleaner | Remover |
| Avery Dennison Blue | sev. st. | v. sl. st | no st. |
| Avery Dennison Red | sev. st. | no st. | no st. |
| BIC Ballpoint Blue | sl. st. | no st. | no st. |
| BIC Ballpoint Black | sev. st. | v. sl. st. | no st. |
| Sharpie (Sanford) Red | sev. st. | sl st. | v. sl. st. |
| Sharpie (Sanford) Black | sl. st. | v. sl. st. | no st. |

CHART 1
APPLICATION

APPLIED COATING AMOUNTS WITH WIRE WOUND RODS*
$Percent Solids = \frac{100 \times Dry Coating Weight ( or Volume )}{Wet Coating Weight ( or Volume )}$

| | | | GRAMS DRY | | | |
|---|---|---|---|---|---|---|
| ROD | WET | | PER SQUARE METER | | | |
| SIZE | THICKNESS | | PERCENT SOLIDS | | | |
| Wire # | Mils | Microns | 30% | 40% | 75% | 100% |
| #2½ | .25 | 6.4 | 1.82 | 2.42 | 4.54 | 6.05 |
| #3 | .3 | 7.6 | 2.18 | 2.91 | 5.47 | 7.29 |
| #4 | .4 | 10.2 | 2.91 | 3.88 | 6.83 | 9.11 |
| #5 | .5 | 12.7 | 3.64 | 4.85 | 9.11 | 12.14 |
| #6 | .6 | 15.2 | 4.38 | 5.82 | 10.93 | 14.58 |
| #7 | .7 | 17.8 | 5.09 | 6.80 | 12.74 | 16.99 |
| #8 | .8 | 20.3 | 5.82 | 7.78 | 14.58 | 19.43 |
| #9 | .9 | 22.9 | 6.56 | 8.34 | 16.40 | 21.87 |
| #10 | 1.0 | 25.4 | 7.28 | 9.71 | 18.21 | 24.28 |
| #11 | 1.1 | 27.9 | 8.00 | 10.69 | 20.04 | 26.72 |
| #12 | 1.2 | 30.5 | 8.74 | 11.65 | 21.87 | 29.16 |
| #13 | 1.3 | 33.0 | 9.47 | 12.63 | 23.71 | 31.60 |
| #14 | 1.4 | 35.6 | 10.20 | 13.60 | 25.51 | 34.00 |
| #15 | 1.5 | 38.1 | 10.93 | 14.58 | 27.32 | 36.41 |
| #16 | 1.6 | 40.6 | 11.65 | 15.54 | 29.14 | 38.85 |
| #17 | 1.7 | 43.2 | 12.38 | 16.51 | 30.99 | 41.29 |
| #18 | 1.8 | 45.7 | 13.11 | 17.49 | 32.78 | 43.70 |
| #19 | 1.9 | 48.3 | 13.85 | 18.45 | 34.61 | 46.14 |
| #20 | 2.0 | 50.8 | 14.58 | 19.43 | 36.41 | 48.55 |

*8 lbs./gallon coating weights assumed. All coating amounts are theoretical. Actual amounts applied may vary depending upon web characteristics and the rheology of coatings.

We claim:

1. A process for producing coated vinyl product comprising the steps of:
(a) supporting and unwinding a roll of vinyl film;
(b) printing a decorative pattern on the unwinding vinyl web at a printing station;
(c) applying an acinic radiation curable liquid coating which is photopolymerizable and curable by exposure to ultraviolet radiation at a coating station in line with printing station; and
(d) converting the liquid coating into a highly stain resistant, solvent resistant solid surface at a rate which is synchronized to steps (b) and (c).
